(19) United States
(12) Patent Application Publication
(10) Pub. No.: US 2006/0214466 A1
(43) Pub. Date: Sep. 28, 2006

(54) Snow cap

(76) Inventor: Davynn L. Davis, Sacramento, CA (US)

Correspondence Address: Davynn L. Davis;United States Post Office, Parkway 4301 Brookfield Dr., Box 233015, Sacramento, CA, 95823, US

(21) Appl. No.: 11/089,419

(22) Filed: Mar. 22, 2005

(51) Int. Cl. B60J 11/00

(52) U.S. Cl. 296/136.11

(57) ABSTRACT

The nature of my invention is a contribution to public safety. It allows snow and ice to be removed from auto windows without scraping which could blur vision and cause accidents. This is done without chemicals, which is also a contribution to EPA.

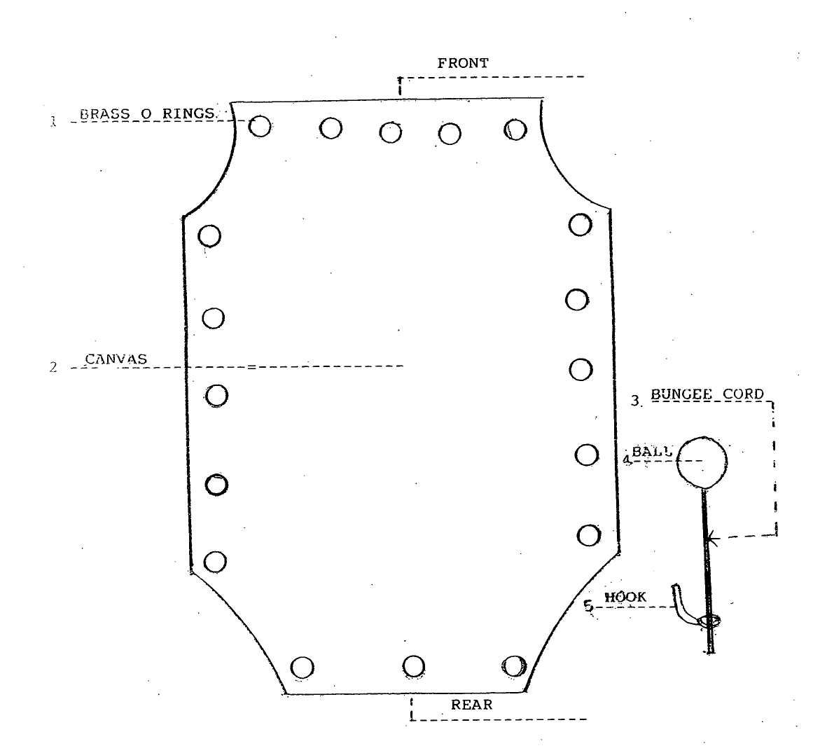

### 1. DECSCRIPTIVE TITLE OF THE INVENTION

The snow cap protects cars, small trucks (pick-ups), and suvs' windows from being covered with snow and ice.

### 2. CROSS REFERENCE TO RELATED APPLICATIONS

(N/A)

### 3. STATEMENT REGARDING FED SPONSORED

(N/A)

### REFERENCE TO SEQUENCE LISTING, A TABLE, OR A COMPUTER PROGRAM LISTING APPENDIX

(N/A)

### 5. BACKGROUND OF INVENTION

(N/A)

### 6. BRIEF SUMMARY OF INVENTION

The general idea of the (SNOW CAP) is to protect windows of autos from snow and ice and prevent damage by not having to scrape to remove.

### 7. BRIEF DESCRIPTION OF DRAWING

Drawing, page 3, description of drawing page 4.

### DETAILED DESCRIPTION

The explanation of this invention is to protect windows of autos (cars, trucks (pickups), and suvs') from snow and ice, and prevent damage to windows by not having to scrape them to remove the snow and ice.

The snow cap is constructed from plastic and nylon, it covers the top and window areas only. It is secured to the auto with bungee cords. The application and removal time is three to five minutes. The life expectancy is three to five years. It is designed to be used by an ordinary skilled or un-skilled person.

1. What I, Davynn L. Davis, of Sacramento, Calif., claim as my invention: Title, Snow Cap. This invention was created, invented and filed for a patent by the above named.

2. There has been a long and waited demand from the public for such an item. The Snow Cap prevents auto windows from being covered with snow and ice, and also prevents damage to windows which could result in accidents from scraping to remove. This is a very positive contribution to society. I am requesting a nonprovivional utility design patent granted by the United States Government.
